(19) United States
(12) Patent Application Publication
(10) Pub. No.: US 2008/0270267 A1
(43) Pub. Date: Oct. 30, 2008

(54) System and method for logistics management

(75) Inventors: Scott A. LeMasters, Dunlap, IL (US); Geoffrey A. LeMasters, Pekin, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/790,591

(22) Filed: Apr. 26, 2007

(51) Int. Cl. G06Q 10/00

(52) U.S. Cl. 705/28

(57) ABSTRACT

A method for logistics management includes receiving recorded employee specific facility data and updated employee specific facility data generated from a facility audit. The method also includes comparing the recorded employee specific facility data and updated employee specific facility data to generate employee specific comparison data. The method further includes generating a report based on the employee specific comparison data, and automatically sending the report in an electronic communication to one or more management entities.

### TECHNICAL FIELD

The present disclosure relates generally to a system and method for use with facilities, and relates more particularly to a system and method for logistics management in facilities.

### BACKGROUND

Facilities may be used for storing goods, including, for example, products, materials, equipment, and documents. The goods may be tracked as they enter a facility, move to and from storage locations within the facility, and are transported out of the facility. By keeping track of the goods, facility operators may have the ability to locate specific items when necessary. In order to track the goods, the facility operators may create records detailing the location of the goods. Such records may be created by conducting a facility audit, where facility personnel may be dispatched to one or more locations in the facility to observe the goods in the one or more locations, and may record their observations. For large facilities that may store many goods in a number of different locations, creating records may consume a significant amount of time and resources. The sheer quantity of records may make organization and analysis of the records particularly difficult. Additionally, ensuring that the records are sent to and received by requesting entities may also prove challenging.

At least one system has been developed to manage audit information generated during review of a facility. For example, U.S. Pat. No. 7,051,046 to Virag et al. (“Virag”) discloses a system for managing audit information which includes receiving audit information, forming audit records, and sending the audit records to a quality assurance reviewer. However, the system in Virag does not generate specific summary reports keyed to locations, features, or entities in a facility. Furthermore, the system in Virag does not automatically send reports to entities tasked with correcting errors or problems uncovered during the audit. As such, the system in Virag does not provide a way to increase the accountability of those entities to help improve facility processes.

The system and method of the present disclosure is directed towards overcoming one or more of the constraints set forth above.

### SUMMARY OF THE INVENTION

In one aspect, the presently disclosed embodiments may be directed to a method for logistics management. The method may include receiving recorded employee specific facility data, and receiving updated employee specific facility data generated from a facility audit. The method may also include comparing the recorded employee specific facility data and updated employee specific facility data to generate employee specific comparison data. The method may further include generating a report based on the employee specific comparison data. The method may further include automatically sending the report in an electronic communication to one or more management entities.

In one aspect, the presently disclosed embodiments may be directed to a method for logistics management. The method may include supervising an area of a facility with a first entity. The method may also include conducting an audit of the area of the facility with a second entity. The method may further include generating a report based on the audit. The report may be indicative of the performance accuracy of the first entity. The method may further include automatically sending the report in an electronic communication to at least one of the first entity and a management entity.

In one aspect, the presently disclosed embodiments may be directed to a system for logistics management. The system may include a data repository configured to store recorded employee specific facility data. The data repository may be in communication with an auditing module. The system may also include an input device used to enter updated employee specific facility data into the auditing module. The auditing module may be configured to receive the recorded employee specific facility data, and also receive the updated employee specific facility data. The auditing module may also be configured to compare the recorded employee specific facility data and the updated employee specific facility data to generate employee specific comparison data. The auditing module may be further configured to generate a report based on the employee specific comparison data. The auditing module may be further configured to automatically send the report in an electronic communication to one or more management entities.

### BRIEF DESCRIPTION OF THE DRAWINGS

FIG. 1 is a schematic illustration of a system for logistics management, according to an exemplary embodiment of the present disclosure.

FIG. 2 is an illustration of a menu window, according to an exemplary embodiment of the present disclosure.

FIG. 3 is an illustration of a data entry window, according to an exemplary embodiment of the present disclosure.

FIG. 4 is an illustration of a data entry window, according to another exemplary embodiment of the present disclosure.

FIG. 5 is a flow diagram of a method for logistics management, according to an exemplary embodiment of the present disclosure.

### DETAILED DESCRIPTION

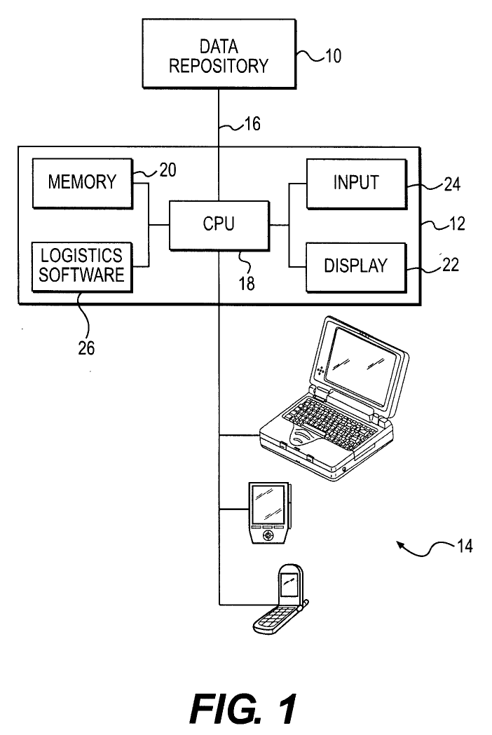

A data repository 10, shown in FIG. 1, may be configured to store facility data. Data repository 10 may include a mainframe, server, and/or any other storage device. The facility data stored in data repository 10 may include inventory information, such as, for example, the types and/or quantities of inventory items and their expected locations in a facility.

A computer system 12 may be operatively coupled to data repository 10. Computer system 12 may include one or more personal computers, laptops, personal digital assistants, or any other suitable computing devices. Computer system 12 may be configured to communicate back and forth with data repository 10 and one or more portable computing devices 14 via a network connection 16, including, for example, LAN, WAN, Internet, Intranet, and/or any other suitable network connection.

In one embodiment, computer system 12 may include a central processing unit 18 (“CPU”), memory 20, a display 22, an input device 24, and logistics software 26. CPU 18 may include a microprocessor, or any other suitable processing device capable of executing software, including operating system software and/or application software, such as logistics software 26. CPU 18 may access data stored in memory 20. Memory 20 may include a hard disk drive, optical drive, flash memory device, and or any other suitable memory device known in the art. Display 22 may include a computer monitor or similar display device. Input device 24 may include a keyboard, mouse, and/or stylus. Input device 24 may also include a scanner, including, for example, a bar code scanner or a radio-frequency (“RF”) tag scanner. The bar code scanner may be used to read data from bar codes on inventory items, while the RF tag scanner may be used to read RF tags on inventory items. It is also contemplated that one or more radio frequency identification tags (“RFID”) may be provided on inventory items, and input device 24 may include a RFID tag reader configured to retrieve data from the one or more RFID tags by emitting radio waves that cause the one or more RFID tags to respond with their data. The use of RF and RFID technology may help to reduce error by automating tasks that would otherwise be performed manually. Moreover, the use of such technologies provides for real time transfer of data, thus helping to ensure that reported data is current and accurate.

Logistics software 26 may include one or more written programs, procedures, rules, and associated documentation. Logistics software 26 may be stored in memory 20, or in a remote location accessible to computer system 12 through a network, such as, for example, the Internet. By running logistics software 26, computer system 12 may act as an auditing module configured to perform facility auditing functions and track performance measures.

The recorded facility data in data repository 10 may include information corresponding to facility locations. For example, the recorded facility data may include the types and/or numbers of inventory items in the facility locations. This recorded facility data may be accessed for use in facility audits. The recorded facility data may also be loaded onto portable computing device 14, that may include laptops, personal digital assistants, cell phones, or any other suitable devices, which may be carried around the facility. Additionally or alternatively, the recorded facility data may be printed out on one or more record-keeping forms.

In a facility, audits may take place randomly, meaning that any location in the facility may be audited at any time. For example, a facility employee may receive a list of work assignments that the employee is to perform. An assignment may include performing an audit of their own work area. Alternatively, the assignment may include performing an audit of a work area assigned to another employee. This may help to maintain randomness by not allowing the employee, as well as other employees, to know who is conducting an audit, or when and where an audit may be conducted. Randomness or unpredictability may help to drive facility personnel to maintain a level of quality in their work, since they may face an audit at any time. This may improve their performance, while also improving accountability. Random auditing may also provide a random sampling of data, giving facility operators and auditors a method for statistically extrapolating performance data for the facility without actually requiring auditing of the entire facility.

During an audit, facility personnel may go to the facility locations, and may enter actual location data at each facility location into portable computing device 14 by, for example, scanning or reading bar codes or tags on inventory items in each facility location. Alternatively, the actual location data may be recorded by manually writing the actual location data in spaces provided for such data in the one or more record-keeping forms. It is also contemplated that a RFID reader may be used to send radio waves to RFID tags on inventory items in each facility location, and the RFID tags will respond by sending data to the RFID reader, thus providing the RFID reader with the actual location data. The recorded facility data and actual location data may be employee specific. For example, the data may correspond to a particular employee or set of employees. Relationships between the data and the one or more employees may be created by, for example, assigning facility locations, inventory items, or work shifts, to the one or more employees. Once the assignments have been made, the activities carried out at the facility locations, with respect to the inventory items, or during the work shifts, may be identified as having been performed by the one or more employees.

Facility personnel may access computer system 12 by, for example, entering a password or by fulfilling any other suitable security measure. The recorded facility data may already be in computer system 12, or may be downloaded by computer system 12 from data repository 10. The actual location data may also be entered into computer system 12. Computer system 12 may store the recorded facility data in one or more facility data fields, and the actual location data in one or more location data fields. It is contemplated that these fields may correspond to memory locations in memory 20. The recorded facility data and the actual location data may collectively form a comprehensive report for the facility.

Uploading the actual location data from the one or more record-keeping documents may involve manually entering the actual location data into computer system 12 using input device 24. Additionally or alternatively, if the actual location data is stored in portable computing device 14, operatively connecting portable computing device 14 to computer system 12 may allow for electronic transfer of the data from portable computing device 14 to computer system 12. The electronic transfer of the data may be accomplished using computer readable storage mediums, data links, wireless communication, and/or any other suitable method of communication known in the art. Once transferred to computer system 12, the facility data and location data may be displayed on display 22 in an organized format, such as, for example, a spreadsheet, chart, or table.

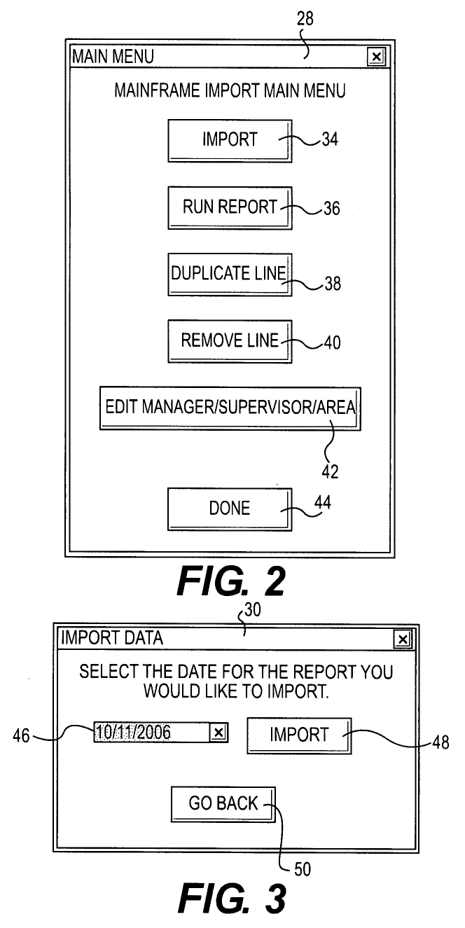

Logistics software 26 may be used to organize and interpret the facility data and actual location data. Logistics software 26 may generate one or more windows, including, for example, a main menu window 28, import data window 30, and run report window 32, examples of which are shown in FIGS. 2-4. Using computer system 12 to run logistics software 26, facility personnel may enter information and make selections in the generated windows to access the recorded facility data and actual location data, and may use such data to help improve logistics processes.

From main menu window 28, depicted in FIG. 2, a series of links, including, for example, import data window button 34, run report window button 36, duplicate line button 38, remove line button 40, edit manager/supervisor/area button 42, and done button 44, may be provided to help users navigate between different features of logistics software 26. The effects of selecting each of these buttons 34, 36, 38, 40, 42, and 44, will be discussed in greater detail below.

When import data window button 34 is selected, computer system 12 may open import data window 30, shown in FIG. 3. A date field 46 may be provided in import data window 30, and may include a pull down menu listing dates for which comprehensive reports are available. Dates may also be directly entered into date field 46 using input device 24. Once a date is entered, selecting an import button 48 may cause the comprehensive report for the selected date, including, for example, all of the recorded facility data and actual location data for that date, to be retrieved by computer system 12. This process of selecting dates may be repeated until each of the dates and corresponding comprehensive reports that are of interest are retrieved. A go back button 50 may also be provided to allow the user to navigate back to main menu window 28.

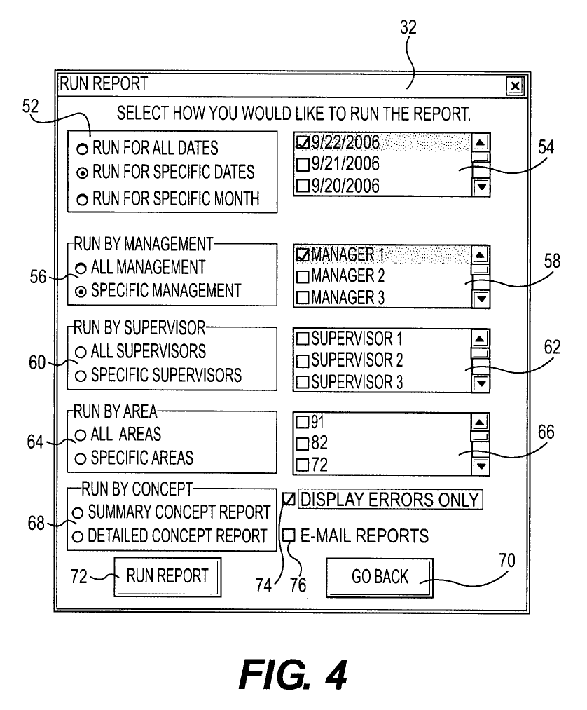

Selecting run report window button 36 may prompt computer system 12 to open run report window 32, shown in FIG. 4. Run report window 32 may be used to retrieve data from the one or more comprehensive reports selected using import data window 30. The retrieved data may include data from a day or range of days that may be selected using a date menu 52 and a date field 54. Additionally or alternatively, the retrieved data may include data pertaining to one or more management entities, including, for example, facility managers, that may be selected using a management menu 56 and a management field 58. Additionally or alternatively, the retrieved data may include data that pertains to other management entities, such as facility supervisors, that may be selected using a supervisor menu 60 and a supervisor field 62. Additionally or alternatively, the retrieved data may include data pertaining to one or more areas that may be selected using an area menu 64 and an area field 66. Additionally or alternatively, it is contemplated that the retrieved data may include data pertaining to facility concepts or features. Either summary concept reports or detailed concept reports may be selected using a run by concept menu 68. A go back button 70 in run report window 32, if selected, may prompt computer system 12 to return to main menu window 28.

Dates selected in import data window 30 may be listed in date field 54. Date menu 52 may be used to select a day or range of days from date field 54. If “Run for All Dates” is selected, all of the dates in date field 54 may be selected. If “Run for Specific Dates” is selected, the dates in date field 54 may not be automatically selected, but rather, may be selected on an individual basis. If “Run for Specific Months” is selected, then upon selection of a date in date field 54, the rest of the dates in the same month may be automatically selected. Data in the comprehensive reports corresponding to the selected dates may be tagged or otherwise identified.

Managers may oversee one or more supervisors, who in turn may supervise one or more areas of the facility. A list of manager names may be provided in management field 58. A management menu 56 may be used to select managers from management field 58. Selecting “All Management” may select each of the managers in management field 58. Selecting “Specific Management” may allow for selection of managers from the list in management field 58 on an individual basis. Data in the comprehensive reports corresponding to the selected managers may be tagged or otherwise identified.

A list of supervisor names may be provided in supervisor field 62. Supervisor menu 60 may be used to select supervisors from supervisor field 62. Selecting “All Supervisors” may select each of the supervisors in supervisor field 62. Selecting “Specific Supervisors” may allow for the selection of supervisors from the list in supervisor field 62 individually. Once supervisors are selected, data in the comprehensive reports corresponding to the selected supervisors may be tagged or otherwise identified.

A list of area names may be provided in area field 66. Each area may represent one or more actual physical locations in the facility, and may also include assets and personnel found in those physical locations. Area menu 64 may be used to select areas from area field 66. Selecting “All Areas” may select each of the areas in area field 66. Selecting “Specific Areas” may allow for selection of areas from the list in area field 66 on an individual basis. Once areas are selected, data in the comprehensive reports corresponding to the selected areas may be tagged or otherwise identified.

The facility may include one or more concepts or features, including, for example, bins, racks, floor locations, and yard locations. Using run by concept menu 68, users may choose to be presented with either a summary concept report or a more detailed concept report, of data in the comprehensive reports corresponding to the various concepts or features.

Run report window 32 may also include a run report button 72. When run report button 72 is selected, computer system 12 may generate a summary report containing the data tagged or otherwise identified according to date menu 52, date field 54, management menu 56, management window 58, supervisor menu 60, supervisor field 62, area menu 64, area field 66, and run by concept menu 68. If a display errors only box 74 in run report window 32 is selected, then the summary report generated by computer system 12 may only display error data, as opposed to displaying the entirety of the tagged recorded facility data and actual location data. In order to identify errors, computer system 12 may compare the actual location data with the recorded facility data, and may automatically identify discrepancies between the two sets of data. One type of discrepancy may arise when the type of inventory items that should be in a facility location according to the recorded facility data do not match the type of inventory items in the facility location according to the actual location data. Another discrepancy may arise when the number of inventory items that should be in a facility location according to the recorded facility data does not exactly match the number of inventory items in the facility location according to the actual location data. These and other discrepancies may be referred to as errors or error data. It is also contemplated that the actual location data may be used to update the recorded facility data so that the recorded facility data more accurately reflects the state of the facility.

If an e-mail reports box 76 is selected, e-mails may be automatically sent to one or more parties, including low level facility personnel, management entities, facility operators, and/or auditors. The summary report may be attached to the e-mail for review by the receiving party. It is also contemplated that instant messages, pages, and/or any other type of suitable communications, may be sent with or in place of e-mails. A record of the e-mails or other communications, including their content, time and date sent, and/or recipients, may be stored in memory 20.

If and when subsequent reports are generated, and new error data is identified, that new error data may be compared with prior error data from a prior summary report. If the new error data matches the prior error data, it may indicate that the party (or parties) responsible for correcting the past error failed to do so, and as such, that the past error has carried through to the present. The record of e-mails or other communications may be analyzed to determine which parties were provided with notice of the error, and when notice was given. Thus, accountability for errors may be more easily determined due to the ease with which the faulty party can be identified.

Keeping the record of e-mails or other communications, and of past summary reports, may also be of assistance in evaluating overall performance with regard to the facility, facility personnel, facility areas, and facility concepts or features. Performance measures that may be pulled and/or calculated from the record and summary reports may include, for example, order accuracy, inventory accuracy, order cycle time, storage utilization, and other suitable metrics. Having access to these performance measures may help facility owners and operators to design better facilities and improve on existing ones, and channel resources to problem areas, by providing them with an indication of the level of performance of the facility, facility personnel, facility areas, and facility concepts or features.

Also, by analyzing the types of errors, their frequency, and where they occurred, it may be possible to diagnose problems and design appropriate solutions. For example, a business that operates a plurality of facilities may analyze error data for each of its facilities, and, if the number of errors in a facility exceed average or acceptable levels, the operations at that facility may receive close scrutiny. The business may determine the dates when the errors occurred, which managers and supervisors were responsible for the errors, and which areas the errors occurred in. If errors occurred with greater frequency on certain dates, under the watch of particular managers or supervisors, or in certain areas, the business may isolate the problem and use its resources to correct it, thus helping to reduce the number of future errors. It is also contemplated that the managers, supervisors, facility areas, and facility concepts or features may be assigned ratings based on the number of errors for which they are responsible, with the ratings being indicative of their performance accuracy.

Selecting edit manager/supervisor/area button 42 on main menu window 28 may call up one or more listings of the management entities, that is, managers and supervisors; areas of the facility; and/or facility concepts or features. The listings may be kept in a file in memory 20, and may be used to populate management field 58, supervisor field 62, and/or area field 66. The listings of the managers, supervisors, and/or areas may be amended by adding, deleting, or modifying the items in the listings. Computer system 12 may automatically verify the additions, deletions, or modifications as they are made to ensure that they are correct.

Situations may arise where the recorded facility data, actual location data, and/or error data may require more fields or lines than expected. In such cases, duplicate line button 38 may be provided in main menu window 28 to allow for creation of new fields or lines for holding the data. If more fields or lines have been provided than may be required, selecting remove line button 40 may remove excess fields or lines.

Computer system 12 may stop or exit from logistics software 26 upon selection of done button 44. However, computer system 12 may prompt users to save before exiting so that any activities and summary reports generated may be retained for use at a later time.

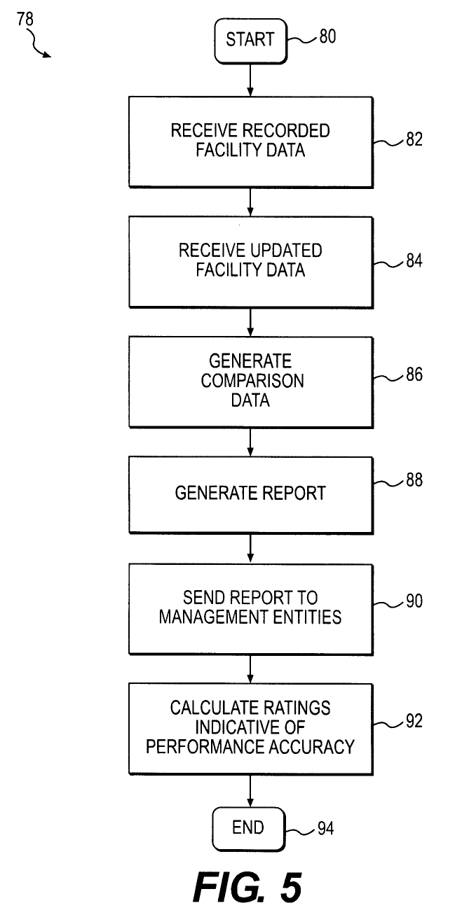

An embodiment of a method 78 for logistics management will now be described with reference to FIG. 5. The method may begin (step 80) with computer system 12 receiving recorded facility data and updated facility data generated from a facility audit (step 82). The facility audit may be performed by an entity, such as, for example, a facility employee, auditor, or consultant. The recorded facility data may be retrieved by computer system 12 from data repository 10, while the updated facility data may be entered using input device 24 or portable computing device 14. The next step may involve comparing the recorded facility data (step 84) and updated or actual facility data to generate comparison data (step 86), which may include error data. With the comparison complete, the next step may include generating a report based on the comparison data (step 88). When generating the report, one or more subsets of the comparison data corresponding to one or more dates, management entities, facility locations, and/or facility features, may be selected for inclusion in the report using main menu window 28, import data window 30, and run report window 32. Afterwards, the report may be automatically sent in an electronic communication to one or more management entities, including, for example, managers and/or supervisors, and also facility owners, operators, and other personnel (step 90). The method may further include using the report to calculate ratings indicative of performance accuracy, order accuracy, inventory accuracy, order cycle time, storage utilization, and other suitable performance metrics for the facility, management entities, areas, and/or concepts or features (step 92). At this point, method 78 may end (step 94).

### INDUSTRIAL APPLICABILITY

The disclosed system 12 and method 78 for logistics management may have applicability in facilities, such as, for example, warehouses or other storage facilities. By automating aspects of auditing processes, including, for example, data collection, analysis, and reporting, efficiency may be improved. Further, by putting reports in electronic form, the system and method may help to eliminate paper waste. These improvements may allow for auditing processes to be carried out more quickly, more frequently, and less expensively. Accordingly, facilities employing the disclosed system 12 and method 78 may have a more accurate understanding of their processes.

Moreover, the disclosed system 12 and method 78 may provide for improved accountability in a facility. By allowing new error data to be compared with the prior error data, the disclosed system 12 and method 78 may provide facility owners and operators with a way to identify the party or parties responsible for errors, and a way to identify the party or parties performing at a high level with few errors. Accountability may be assigned more easily due to the ease with which the faulty party or parties can be identified. By differentiating between underperforming and adequately performing areas, a facility's owners and operators can more clearly identify problem areas and potential solutions. Additionally, facility owners and operators may use system 12 and method 78 regularly to monitor performance, providing the with a way to pinpoint problems with minimal delay.

It will be apparent to those skilled in the art that various modifications and variations can be made in the disclosed system and method without departing from the scope of the disclosure. Additionally, other embodiments of the disclosed system and method will be apparent to those skilled in the art from consideration of the specification. It is intended that the specification and examples be considered as exemplary only, with a true scope of the disclosure being indicated by the following claims and their equivalents.

What is claimed is:

1. A method for logistics management, the method comprising:
receiving recorded employee specific facility data;
receiving updated employee specific facility data generated from a facility audit;
comparing the recorded employee specific facility data and updated employee specific facility data to generate employee specific comparison data;
generating a report based on the employee specific comparison data; and
automatically sending the report in an electronic communication to one or more management entities.

2. The method of claim 1, wherein generating the report based on the employee specific comparison data includes selecting a subset of the employee specific comparison data corresponding to one or more dates for the report.

3. The method of claim 1, wherein generating the report based on the employee specific comparison data includes selecting a subset of the employee specific comparison data corresponding to one or more management entities for the report.

4. The method of claim 1, wherein generating the report based on the employee specific comparison data includes selecting a subset of the employee specific comparison data corresponding to one or more one or more facility locations for the report.

5. The method of claim 1, wherein generating the report based on the employee specific comparison data includes selecting a subset of the employee specific comparison data corresponding to one or more facility features for the report.

6. The method of claim 1, further including using the report to determine a rating indicative of performance accuracy.

7. The method of claim 1, further including automatically sending the report in an electronic communication to one or more employees.

8. A method for logistics management, the method comprising:
supervising an area of a facility with a first entity;
conducting an audit of the area of the facility with a second entity;
generating a report based on the audit, wherein the report is indicative of the performance accuracy of the first entity; and
automatically sending the report in an electronic communication to at least one of the first entity and a management entity.

9. The method of claim 8, wherein generating the report based on the audit includes comparing recorded employee specific facility data with audit data to generate employee specific comparison data.

10. The method of claim 9, wherein generating the report based on the audit includes selecting a subset of the employee specific comparison data corresponding to one or more dates for the report.

11. The method of claim 9, wherein generating the report based on the audit includes selecting a subset of the employee specific comparison data corresponding to one or more management entities for the report.

12. The method of claim 9, wherein generating the report based on the audit includes selecting a subset of the employee specific comparison data corresponding to one or more facility locations for the report.

13. The method of claim 9, wherein generating the report based on the audit includes selecting a subset of the employee specific comparison data corresponding to one or more facility features for the report.

14. The method of claim 8, further including using the report to determine a rating indicative of performance accuracy for the first entity.

15. A system for logistics management, the system comprising:
a data repository configured to store recorded employee specific facility data, wherein the data repository is in communication with an auditing module;
an input device used to enter updated employee specific facility data into the auditing module;
wherein the auditing module is configured to:
receive the recorded employee specific facility data;
receive the updated employee specific facility data;
compare the recorded employee specific facility data and the updated employee specific facility data to generate employee specific comparison data;
generate a report based on the employee specific comparison data; and
automatically send the report in an electronic communication to one or more management entities.

16. The system of claim 15, wherein the auditing module is further configured to select a subset of the employee specific comparison data corresponding to one or more dates for the report.

17. The system of claim 15, wherein the auditing module is further configured to select a subset of the employee specific comparison data corresponding to one or more management entities for the report.

18. The system of claim 15, wherein the auditing module is further configured to select a subset of the employee specific comparison data corresponding to one or more one or more facility locations for the report.

19. The system of claim 15, wherein the auditing module is further configured to select a subset of the employee specific comparison data corresponding to one or more facility features for the report.

20. The system of claim 15, wherein the input device includes a radio-frequency identification device.

21. The system of claim 15, wherein the input device includes a bar code reader.
